(19) United States
(12) Patent Application Publication
(10) Pub. No.: US 2020/0080535 A1
(43) Pub. Date: Mar. 12, 2020

(54) LINEAR VERNIER GENERATOR FOR WAVE ENERGY CONVERSION

(71) Applicant: Oscilla Power, Inc., Seattle, WA (US)

(72) Inventor: Jennifer Vining, Seattle, WA (US)

(73) Assignee: Oscilla Power, Inc., Seattle, WA (US)

(21) Appl. No.: 15/965,662

(22) Filed: Apr. 27, 2018

(51) Int. Cl. F03B 13/14; H02K 7/18

(52) U.S. Cl. CPC F03B 13/14; H02K 7/1876

(57) ABSTRACT

An apparatus converts mechanical energy to electrical energy. The apparatus includes a linear electrical generator. The linear electrical generator includes at least one translator with translator poles and at least one stator with stator poles. The stator poles are aligned with the translator poles according to a Vernier scale. For given lengths of the stator and translator, the number of stator poles in the stator is offset by an integer number of translator poles in the translator.

This application claims the benefit of U.S. Provisional Application No. 62/491,121, filed on Apr. 27, 2017, which is incorporated by reference herein in its entirety.

Wide deployment of renewable energy sources that are both commercially viable and environmentally benign unquestionably ranks as one of today's global grand challenges. Such technologies may fuel economic growth and contribute to global environmental sustainability, and also reduce our dependence on exhaustible fossil fuels in the coming decades. Ocean power and other renewable energy sources have very high potential but are under-utilized sources for clean energy that would accomplish these objectives.

The Energy Information Administration estimates that global electricity consumption will increase from 18 to 32 trillion kWh between 2006 and 2030, reflecting an annual growth rate of 2.4%. Coal power is forecast to deliver 42% of this global increase, followed by renewables at 24% and natural gas at 23%, with nuclear power contributing the balance. U.S. electricity consumption will increase at a slower rate, climbing from 4.1 to 5.2 trillion kWh over this time period. Coal power is forecast to deliver 39% of this domestic increase, followed by renewables at 32% and natural gas at 18%. The bulk of the contribution from renewables is projected to come from new hydropower rather than less environmentally compromising renewables.

The identification and development of new cost-effective, energy-efficient and environmentally friendly power generation technologies will result in economic, health and security benefits to the U.S. and global populations. Since clean energy generation is generally based on local resources, these technologies can help fuel the local economies of coastal areas through job creation and the availability of inexpensive energy to fuel local industries.

A high proportion of the market share growth in the clean energy sector may go to energy sources that have the capital efficiency, cost effectiveness, and resource availability to scale quickly over the next two decades. Conventional approaches to harvesting ocean energy, for example, have been delinquent across all three of these criteria—they are too capital intensive, have non-competitive energy costs, and may require very specific ocean environments which limits the number of potential locations and thus the scale of impact. As such, conventional ocean energy systems are not considered to be in the same class as wind, solar photovoltaic, solar thermal, and geothermal when it comes to impact potential.

The cost of electricity from conventional devices is estimated to be 3-5 times that of coal power. Without radical departures from the conventional approach tried to date, it is plausible that ocean energy will never be a material part of the global energy mix. New approaches and technologies, such as the novel generator described here, are needed to reduce the cost of energy down to sufficiently low levels.

Embodiments of an apparatus are described. In one embodiment, the apparatus is an apparatus for harvesting electrical power from mechanical energy. The energy harvesting apparatus includes a translator, and a stator. The translator is configured so that loads and/or displacements that may or may not be conditioned/modified through other means, caused by the action of ocean wave forces acting on a floating body, are transferred to the translator causing it to move relative to the stator. The translator and stator are configured such that this motion results in magnetic flux changes, that can be converted to electrical energy through electromagnetic induction in coils comprising conductive metal wire that are also part of the apparatus.

In another embodiment, the apparatus converts mechanical energy to electrical energy. The apparatus includes a linear electrical generator. The linear electrical generator includes at least one translator with translator poles and at least one stator with stator poles. The stator poles are aligned with the translator poles according to a Vernier scale. For given lengths of the stator and translator, the number of stator poles in the stator is offset by an integer number of translator poles in the translator.

Other aspects and advantages of embodiments of the present invention will become apparent from the following detailed description, taken in conjunction with the accompanying drawings, illustrated by way of example of the principles of the invention.

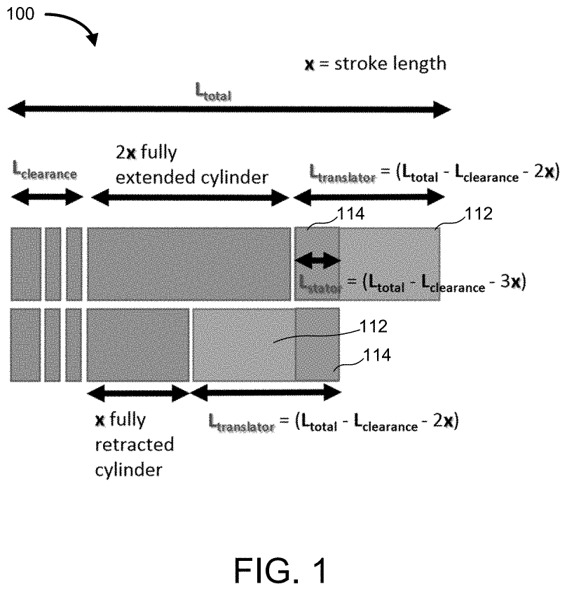

FIG. 1 depicts a schematic diagram of one embodiment of a linear Vernier generator.

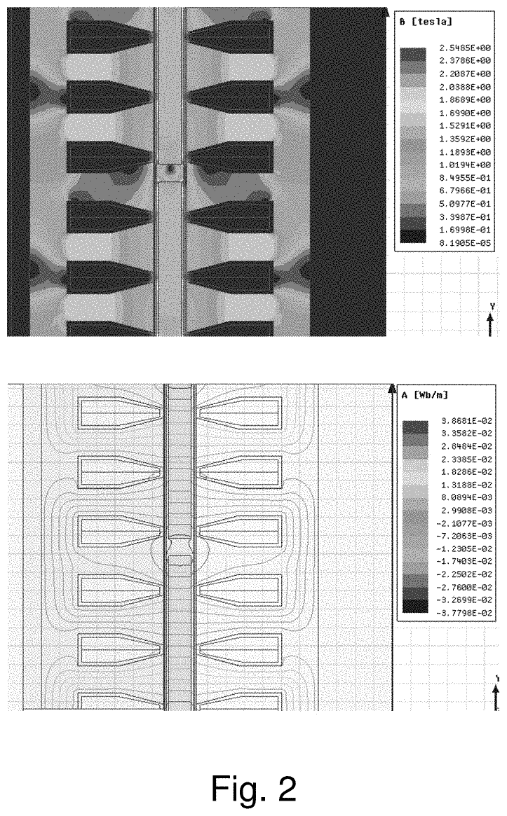

FIG. 2 depicts a graphical diagram of magnetic flux density (top) and flux lines (bottom) for an embodiment of a surface permanent magnet machine.

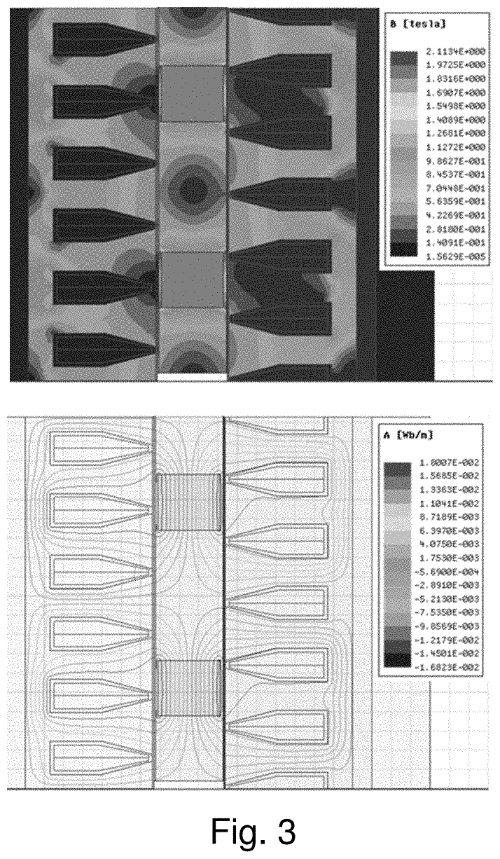

FIG. 3 depicts a graphical diagram of magnetic flux density (top) and flux lines (bottom) for an embodiment of an axial permanent magnet machine.

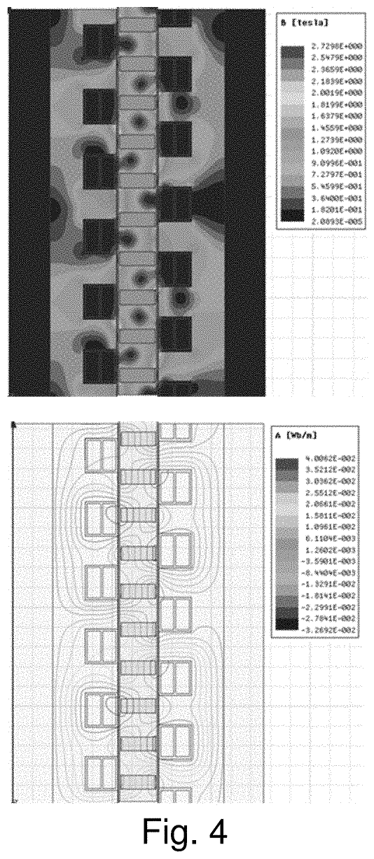

FIG. 4 depicts a graphical diagram of magnetic flux density (top) and flux lines (bottom) for an embodiment of a Vernier permanent magnet machine.

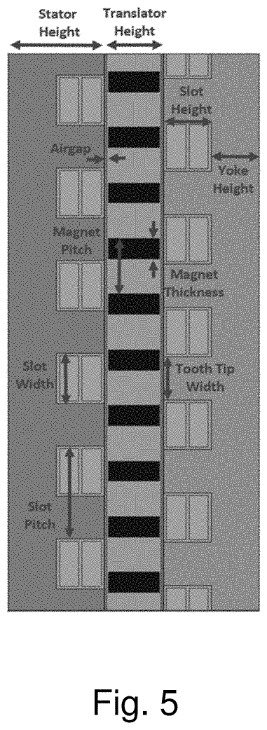

FIG. 5 depicts a schematic diagram of one embodiment of linear generator.

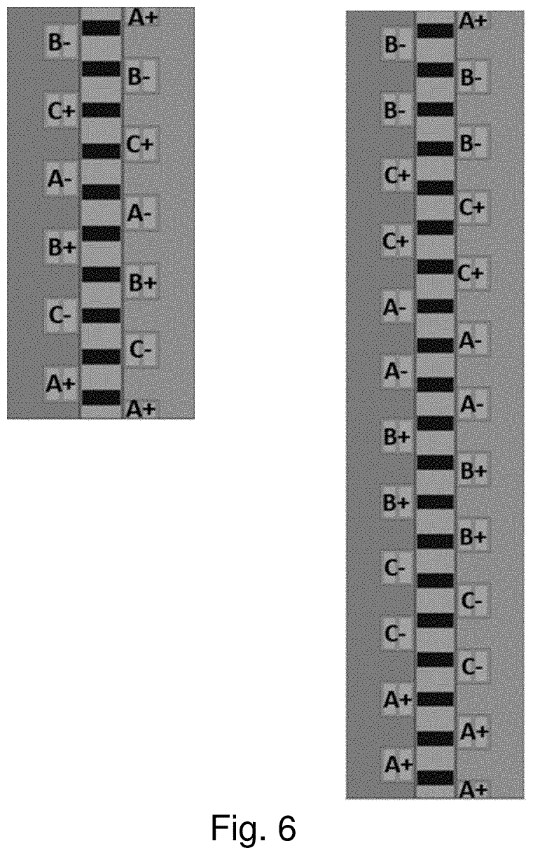

FIG. 6 depicts schematic diagrams of embodiments of a linear Vernier generator.

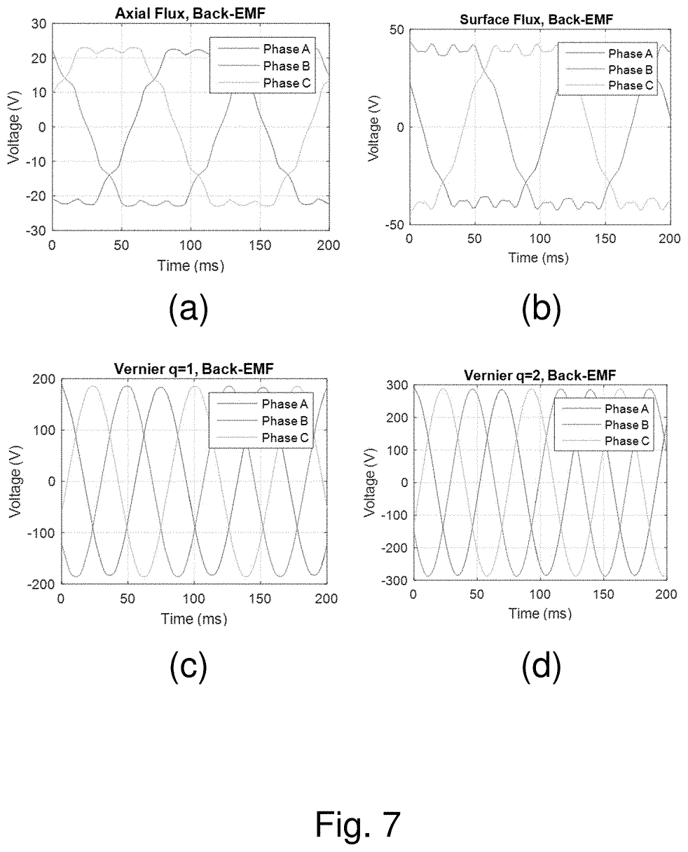

FIG. 7 depicts waveforms of one embodiment of back EMF of machines at rated 1 m/s translator Speed over 200 ms. In particular, waveform (a) is representative of an axial flux permanent magnet (PM) machine characterized by Vₚₖ=23V, ω_{dec}=16.3 rad/s, and f_{elec}=2.6 Hz) @ 1 m/s. Waveform (b) is representative of a surface PM machine characterized by Vₚₖ=42V, ω_{dec}=16.3 rad/s, and f_{elec}=2.6 Hz @ 1 m/s. Waveform (c) is representative of a Vernier machine with q=1 characterized by Vₚₖ=185V, θ_{dec}=81.6 rad/s, and f_{elec}=13 Hz @ 1 m/s. Waveform (d) is representative of a Vernier machine with q=2 characterized by Vₚₖ=287V, ω_{dec}=89.8 rad/s, and f_{elec}=14.3 Hz @ 1 m/s.

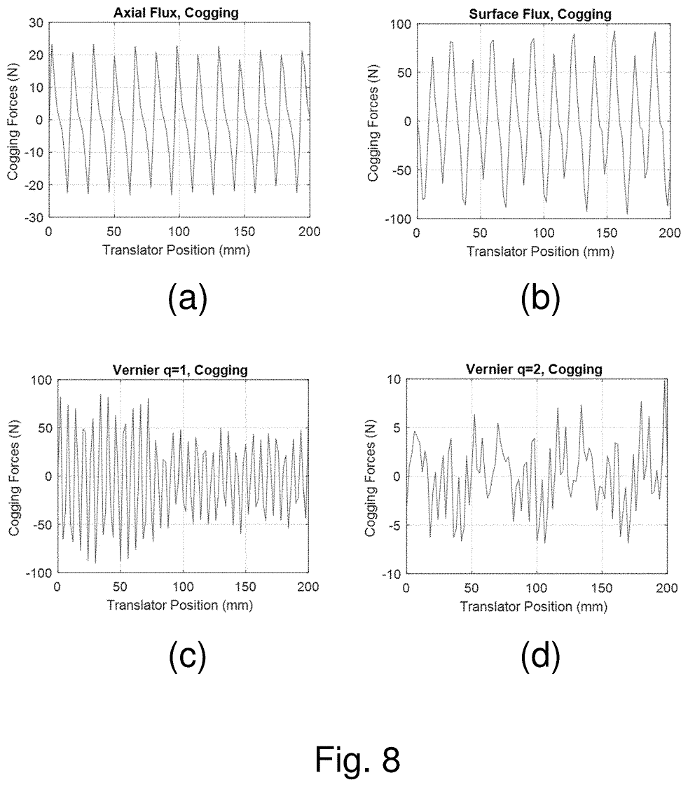

FIG. 8 depicts waveforms of one embodiment of cogging forces over 200 mm displacement. In particular, waveform (a) is representative of an axial flux PM machine characterized by 45N variation over 200 mm displacement. Waveform (b) is representative of a surface PM machine characterized by 185N variation over 200 mm displacement. Waveform (c) is representative of a Vernier machine with q=1 characterized by 178N variation over 200 mm displacement. Waveform (d) is representative of a Vernier machine with q=2 characterized by 15N variation over 200 mm displacement.

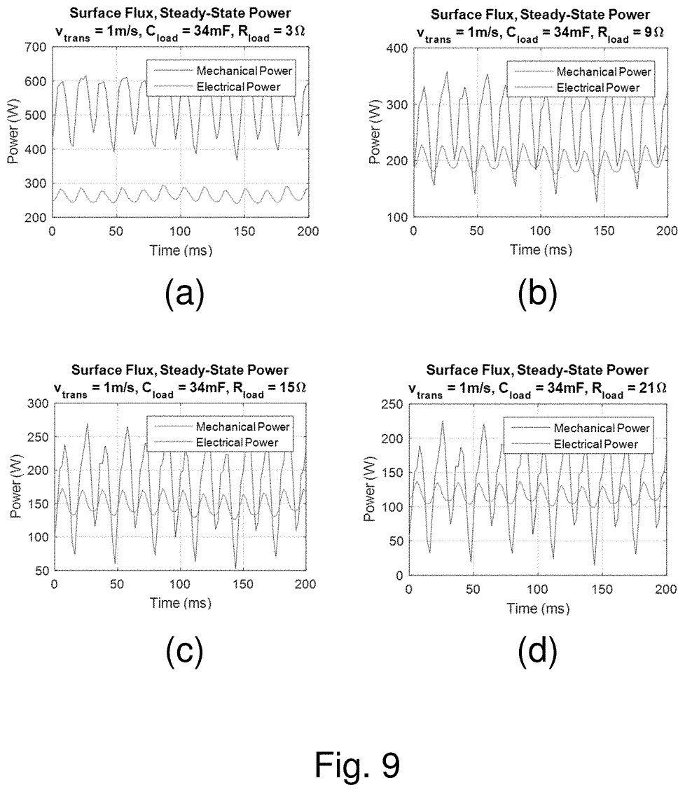

FIG. 9 depicts waveforms of one embodiment of electrical versus mechanical power for individual load points for a surface PM machine. In particular, waveform (a) is characterized by R_{load}=3Ω, Electrical Power=275 W, Mechanical Power=500 W. Waveform (b) is characterized by R_{load}=9Ω, Electrical Power=200 W, Mechanical Power=275 W, with partial motoring due to cogging. Waveform (c) is characterized by R_{load}=15Ω, Electrical Power=150 W, Mechanical Power=175 W, with partial motoring due to cogging. Waveform (d) is characterized by R_{load}=21Ω, Electrical Power=125 W, Mechanical Power=150 W, with partial motoring due to cogging.

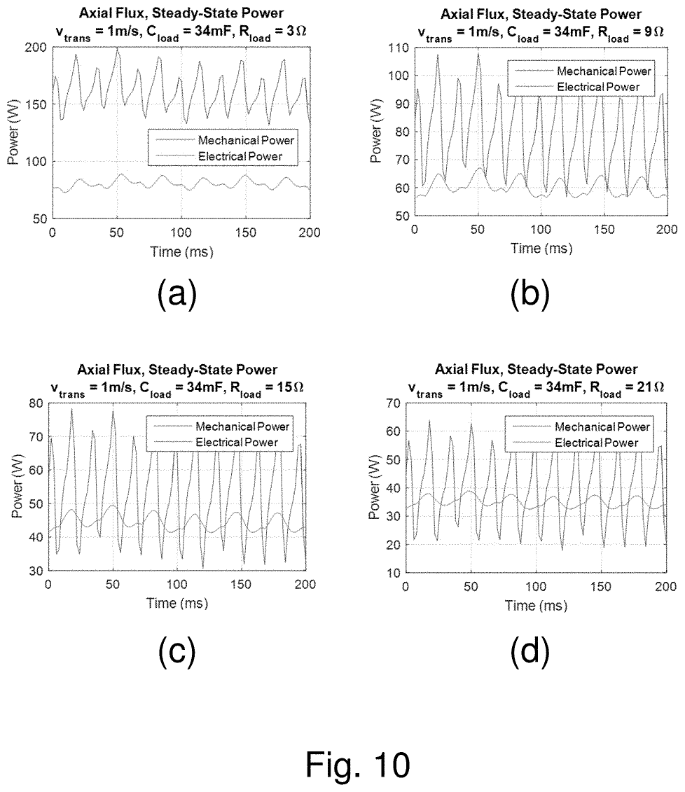

FIG. 10 depicts waveforms of one embodiment of electrical versus mechanical power for individual load points for an axial flux PM machine. In particular, waveform (a) is characterized by R_{load}=3Ω, Electrical Power=80 W, Mechanical Power=165 W. Waveform (b) is characterized by R_{load}=9Ω, Electrical Power=60 W, Mechanical Power=80 W, with partial motoring due to cogging. Waveform (c) is characterized by R_{load}=15Ω, Electrical Power=45 W, Mechanical Power=56 W, with partial motoring due to cogging. Waveform (d) is characterized by R_{load}=21Ω, Electrical Power=35 W, Mechanical Power=40 W, with partial motoring due to cogging.

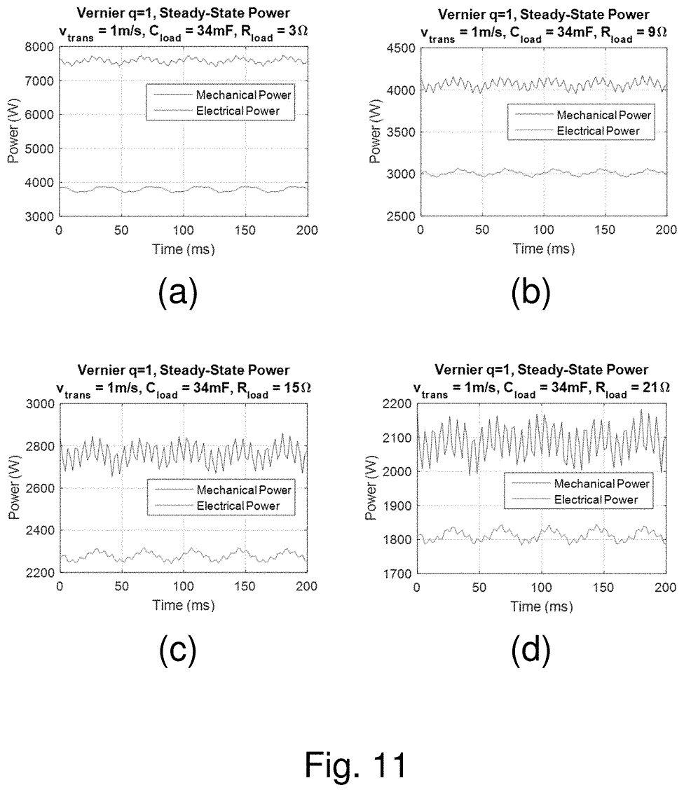

FIG. 11 depicts waveforms of one embodiment of electrical versus mechanical power for individual load points for a Vernier PM machine with q=1. In particular, waveform (a) is characterized by R_{load}=3Ω, Electrical Power=3.8 kW, Mechanical Power=7.6 kW, and Efficiency=50%. Waveform (b) is characterized by R_{load}=9Ω, Electrical Power=3 kW, Mechanical Power=4.1 kW, and Efficiency=73%. Waveform (c) is characterized by R_{load}=15 0, Electrical Power=2.3 kW, Mechanical Power=2.75 kW, and Efficiency=84%. Waveform (d) is characterized by R_{load}=21Ω, Electrical Power=1.8 kW, Mechanical Power=2.1 Kw, and Efficiency=86%.

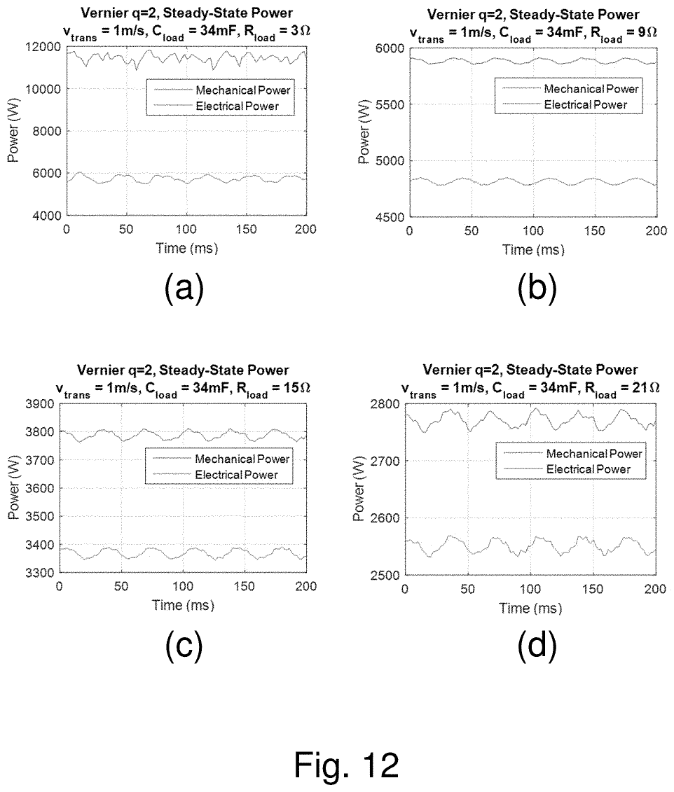

FIG. 12 depicts waveforms of one embodiment of electrical versus mechanical power for individual load points for a Vernier PM machine with q=2. In particular, waveform (a) is characterized by R_{load}=3Ω, Electrical Power=5.6 kW, Mechanical Power=11.4 kW, and Efficiency=49%. Waveform (b) is characterized by R_{load}=9Ω, Electrical Power=4.95 kW, Mechanical Power=5.88 kW, and Efficiency=84%. Waveform (c) is characterized by R_{load}=15Ω, Electrical Power=3.4 kW, Mechanical Power=3.8 kW, and Efficiency=89%. Waveform (d) is characterized by R_{load}=21Ω, Electrical Power=2.55 kW, Mechanical Power=2.8 kW, and Efficiency=91%.

Throughout the description, similar reference numbers may be used to identify similar elements.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Wave energy conversion using a buoy-type or point absorber-type of wave energy converter (WEC) develops mechanical power in a linear motion as opposed to the rotary motion of conventional generators. This poses a problem in that conventional rotary generators cannot be used to capture power directly. One approach to solving this problem employs a mechanism to convert the linear motion to rotary motion (i.e. hydraulic pump, rack and pinion, etc.). Not only does this add unnecessary complexity, it also increases the number of failure modes and decreases efficiency.

Another approach to solving this problem is the use of a linear generator which requires no conversion to rotary motion. While this approach is not new, the challenges posed by converting the low speed linear WEC motion into electricity with a linear generator have so far limited wide-spread adoption. The primary challenge in this design is the inherent low speed of the translator which reduces machine goodness. Another challenge is reduction of cogging forces which have plagued other linear generator designs.

Operating conditions requiring low speeds yield generator characteristics such as a large number of coil turns. This results in a large machine inductance, which causes low power factor and poor machine regulation.

According to Faraday's Law of Induction, a change in magnetic flux induces voltage; however, a slow moving translator causes slow flux change and low induced voltage. Therefore, more winding turns (for larger flux linkage) are necessary to elevate the induced voltage to a desired level. This increases the machine inductance and thus lowers the power factor.

The real power output of the machine is dependent on the power factor of the machine. Due to the large inductance in linear generators, the power factor is low. A power factor closer to unity is desired to obtain the maximum power output and efficiency. As a control parameter, the power factor may be optimized to the wave climate. Well-known techniques such as parallel compensation capacitors or active rectifiers may be used to correct the power factor. The problem with such a low power factor is that the converter must be overrated. For example, a 0.3 power factor linear generator requires a converter overrated by a factor of over three. As a summary of the cause and effect chain, a lower translator speed results in a need for a large number of coil turns for a rated voltage, which in turn results in high inductance and, ultimately, a lower power factor.

Due to the slow moving nature of the translator in a WEC application, a larger generator is required to produce power similar to a conventional high speed generator. As the generator size is scaled up, the cogging forces also scale up. Cogging forces are a major concern in large machines since they can exert hundreds of kilo-Newtons (kN) of force on the bearings, especially with stronger magnets. This not only interferes with power capture in low wave energy states since it opposes movement of the translator, it also causes major mechanical problems such as vibration, which can damage the bearings and warp the airgap. And while a larger airgap is less sensitive to wear caused by these forces, it imparts poor electrical efficiency.

Cogging forces are caused by a magnetic attraction between the stator teeth and the translator permanent magnets. More specifically, the magnet and teeth edges repel/attract each other due to abrupt changes in permeance as the translator passes, thus producing cogging forces. Slotless iron-cored machines (in which coils are placed within the airgap) experience less cogging than slotted machines, however slotless machines have less force density than slotted machines and hence have lower power density.

Embodiments described herein are specifically aimed at increasing power factor and reducing cogging forces. Some embodiments implement a linear Vernier machine or linear Vernier generator for ocean wave energy conversion (the words ‘machine’ and ‘generator’ are used interchangeably as generators are ‘electric machines’). Some embodiments implement a device comprising a linear Vernier machine/generator for use in wave energy conversion. Some embodiments facilitate a method of using a linear Vernier machine/generator for use in wave energy conversion. Some embodiments implement a linear generator that uses a Vernier topology which may be used in any application.

Some embodiments enable highly efficient, low speed high force operation with low cogging and high power factor. In some embodiments, the high force, low speed functionality is achieved due to Vernier flux modulation effect.

Embodiments incorporate one of two topologies for the relative length of the stator and the translator. A first topology includes a long secondary (translator) and a short primary (stator) where the translator is longer than the stator. A second topology includes a short secondary (translator) and a long primary (stator) where the stator is longer than the translator. In some embodiments, improved electromagnetic performance can be achieved using the first topology with a long secondary (translator) and a short primary (stator) configuration. In further embodiments for high performance, the translator always occupies the stator's magnetic active area. The translator and stator length can be determined and implemented to accommodate stroke length. FIG. 1 depicts a schematic diagram of one embodiment of a linear Vernier generator 100. The depicted linear Vernier generator 100 has a topology with a long secondary translator 112 and a short primary stator 114 with stroke length ‘x’ confined to a total length Lₜₒₜₐₗ.

In one embodiment, the translator 112 includes a Vernier permanent magnet structure, examples of which are shown in FIGS. 4-6 where the number of magnet poles is related the number of stator winding pole poles and stator teeth according to equation (1) where the combination (Stator teeth)−(Winding pole pairs) yields higher power. The magnets are axially magnetized

(Magnet pole pairs)=(Stator teeth)±(Winding pole pairs) (1)

In one embodiment, the stator 114 includes a simple open slot structure with a polyphase winding. It is possible to use one or two stators. In other embodiments, it may be possible to use more than two stators. If using two stators, the two stators can be axially offset from each other by half a slot pitch as shown in FIGS. 4-6 to increase flux coupling and reduce cogging forces.

In some embodiments, scale up of the machine can be accomplished in a modular fashion by adding more pole pairs (increasing machine length) and/or increasing the lamination stack length (increasing machine width).

In some embodiments, various structural features such as bearings, bearing mounts, trusses, load frames, etc. may be integrated structurally with, including within the body of, the Vernier linear machine to limit deflections of components such as the translator.

Some embodiments may employ a dual sided stator.

Depending on the operational capabilities that are desired in a particular embodiment of a linear Vernier generator, some or all of the following criteria may be varied depending on the physical, structural components of the linear Vernier generator, including: (1) higher power density, (2) low cogging forces, (3) smaller power electronics footprint, i.e., higher power factor, etc., (4) ease of manufacture, (5) robustness, i.e., reliability, and (6) cost.

Some embodiments described herein include a class of permanent magnet machines. Permanent magnet machines are generally an efficient and power dense class of electric machines. The high-energy product of NdBFe magnets combined with their low weight attest to the power these magnets can deliver.

Current state-of-the-art linear generators employ conventional surface permanent magnets with distributed windings. These typically have a radial permanent magnet alignment. One of the main drawbacks of this machine topology is its high cogging force. Consequently, particular attention must be paid to reducing cogging forces.

There are several possible ways to reduce cogging forces including skewing the magnets or winding slots, shaping the magnets, or using Halbach magnetization. Another answer to this issue and, in an attempt to increase power density, research has extended to axial flux topologies where the magnets face each other via a ‘flux bridge’ in the secondary rather than radial alignment. This produces a more sinusoidal flux distribution in the airgap and helps alleviate cogging.

There are other ways to minimize cogging by reducing the iron/magnet interaction. One method is to go slotless where the stator coils are placed directly in the airgap. Another method is to remove all iron entirely for an air-cored design. Both of these methods reduce cogging at the cost of power density and power factor as air is orders of magnitude less magnetically permeable than iron.

Embodiments include a class of flux modulation machines. These machines work based on the magnetic gear effect in which a high speed mover actuates a low speed mover or vice-versa via a magnet array. The flux modulation machine combines the magnetic gear's three components into two parts—a primary (stator) and secondary (translator). Flux modulation machines come in many different varieties such as flux reversal, flux switching, Vernier, and Vernier hybrid without significantly departing from the conventional PM machine topology.

Among the flux modulation topologies, both the flux reversal and flux switching architectures feature permanent magnets in the stator. Given that the stator is typically shorter than the translator in linear machines (for constant active area during each stroke), placing magnets on the stator instead of the translator reduces the overall cost of the machine. These topologies compete well with conventional PM machines in terms of power density and actually outperform them in terms of cogging; their potential drawback seen in the literature is incomplete testing results and a lack of attention to power factor which is not reported. It is hard to say with confidence that these topologies do not suffer from poor power factor, as the FEA results presented tend to suggest that there is significant flux leakage.

Embodiments described herein employ a Vernier PM topology. Some embodiments of this topology enjoy superior power density over conventional surface permanent magnet machines and lower cogging forces as well. Some embodiments of this topology also achieve power factors in the range of 0.8-0.9 which leads to size reduction requirements for the power electronics package.

In addition to the impact that improved power factor has on shrinking the power electronics package, a higher electrical frequency also aids in reducing the power electronics footprint as power smoothing is more easily achieved at higher electrical frequencies. This is another strong point of the flux modulation topology since the working principle on which the Vernier topology is based yields a higher electrical frequency than a conventional permanent magnet machine.

Aside from its many notable electromagnetic characteristics, the Vernier machine also features a fairly rugged construction. The open slot structure makes winding and fabrication of the laminations easier. Some embodiments may have a double-sided topology. Some embodiments may employ a tubular topology. A tubular design is superior in terms of maximizing active electromagnetic area for a given volume with the drawbacks that (1) integrating support bearings for a larger machine, i.e. longer translator, is difficult without access to sections within the active area, (2) a solid stator is required as laminations are not an option for this longitudinal flux topology, (3) coil winding would require a modular stator so as to insert each coil. As an answer to these issues, multiple flat stator sections can be abutted together to form a square, hexagonal, or octagonal stator. While these provide the benefits of a tubular geometry, they also add complexity of construction. For the most part a double-sided topology is easier to manufacture in terms of winding and bearing integration, as well as for reducing maintenance and levelized replacement costs.

Some embodiments also employ a mechanical or hydraulic mechanism that that can amplify displacement and speed of the translator which positively affects the overall efficiency and reduces the size of the generator by increasing the stroke velocity and decreasing the required reactive force (this mechanism is herein termed a “linear gearbox”). A generator with higher velocity and lower force requires fewer coil turns (i.e. less copper) and less back iron which ultimately leads to a smaller machine. The decrease in coil turns reduces the machine inductance with the effect of improving the power factor and hence efficiency. By incorporating the linear gearbox, we ameliorate some of the factors that make low speed, high thrust force machines difficult to design.

Different linear machine topologies have distinct relative merits within the realm of wave energy conversion—i.e. low speed and high thrust. FIGS. 2-4 provide examples of different linear machine topologies. In particular, FIG. 2 depicts a graphical diagram of magnetic flux density (top) and flux lines (bottom) for an embodiment of a surface permanent magnet machine. FIG. 3 depicts a graphical diagram of magnetic flux density (top) and flux lines (bottom) for an embodiment of an axial permanent magnet machine. FIG. 4 depicts a graphical diagram of magnetic flux density (top) and flux lines (bottom) for an embodiment of a Vernier permanent magnet machine.

An analysis can be performed to determine power, efficiency, cogging forces, and power density within a standardized machine design envelope. The envelope includes several design criteria which were selected to enable a relative comparison between the generator topologies.

Note that we chose to constrain the generator size rather than size each generator to provide the same reactive force per unit speed. The two approaches ultimately yield the same fundamental result (power density). Overall, an analysis with a fixed machine size is somewhat faster to perform and emphasizes the fact that given the same generator size the performance differs significantly.

The design envelope constrains the size of generator in order to facilitate comparison of the different types of machines. Each machine topology was developed using the following constraints:
Same wire gauge
   6 AWG with 50% fill factor
Same stator height (yoke+tooth)
   66 mm per stator stack
Same length and lamination stack height (i.e. same magnetic active area)
   Length=1.54 m
   Stack height=0.1 m
Same slot pitch, slot width, and tooth width (tooth shape at airgap not constrained, enabling open/closed slot differences)
   Slot pitch=64.17 mm
   Slot width=34.67 mm
   Tooth width=29.5 mm
Double sided stator with offset between left and right stator stack for cogging reduction
All magnets and windings are unskewed. Stator and/or translator skewing is not considered

FIG. 5 depicts a schematic diagram of one embodiment of linear generator, with several annotations to designate characteristics referenced above.

Additionally, the following analysis considers the following key machine characteristics in making a relative evaluation:
Power & power density
Efficiency
Cogging forces
Machine inductance
Machine mass of electrical steel, copper, and permanent magnet material

Within the constrained design envelope—i.e. same magnetic active area, three machine topologies were analyzed via 2D finite element (FE) analysis using the Ansoft (ANSYS) Maxwell package.

The FE analysis consists of a single pole pair in order to exploit symmetry and reduce computation time. Given that we are most interested in the primary electromagnetic characteristics of the airgap stator/translator interaction, we may only use a 2D model rather than a 3D model, which is primarily useful for modeling end effects. This reduces computation time significantly. As per typical FE analysis, the user should exploit all symmetries possible to improve simulation time. Following this rule of thumb, it is only necessary to model one pole pair as this can be assigned a periodic boundary condition. For the needs of a study, the FE analysis tool solves for a time-varying (transient) magnetic vector potential, A, given a set of boundary conditions including motion, external circuits, permanent magnet fields, coils, etc. and then derives other data from this, e.g. coil voltage and current, electromechanical forces, etc. Results of the one pole pair are scaled to the design envelope's axial length of 1.54m and stack height of 0.1 m within the FE tool.

Other than the unique translator magnet configurations, the only difference between these different generator designs is the tooth shape (open vs. closed slot) where the slot width and tooth width are kept constant.

Several parameters for the surface and axial flux topologies were evaluated to maximize back EMF and reduce cogging:
Magnet pole arc and magnet width (Note: magnet width scales with translator width (measured between stators) as the magnet occupies entire width minus retaining wall.)
Slot depth
Tooth tip width (for closed slot design)
Offset of right stator stack with respect to left stator

Table 1 lists the specifications for each topology.

TABLE 1
Machine Topology Characteristics

| | Magnet Pole Arc | | | Stator Offset | |
|---|---|---|---|---|---|
| Machine | (axial % of pole | Translator | Stator Tooth Tip | (skew between | |
| Topology | occupied by magnet) | Height | Width | stator stacks) | Slot Height |
| Surface PM | 90% | 15 mm | tooth width + 0.5*slot | 0.5 * stator | 0.75 * stator |
| | | | width (closed slot) | slot pitch | height |
| Axial PM | 30% | 35 mm | tooth width + 0.8*slot | 0.5 * stator | 0.8 * stator |
| | | | width (closed slot) | slot pitch | height |
| Vernier, | 36% | 38 mm | tooth width + 0*slot | 0.5 * stator | 0.5 * stator |
| q = 1 | | | width (open slot) | slot pitch | height |
| Vernier, | 40% | 38 mm | tooth width + 0*slot | 0.5 * stator | 0.5 * stator |
| q = 2 | | | width (open slot) | slot pitch | height |

Flux coupling and electrical frequency at a given speed couple to produce a machine's back EMF. The higher the flux coupling and electrical frequency, the higher the back EMF. For a low speed application, the machine designer aims to boost back EMF as much as possible to increase machine efficiency, which can be a challenge for the very low speeds typical of wave energy conversion.

Both the surface PM and axial flux PM were designed with a one slot-per-pole-per-phase (q=1) configuration in order to increase electrical frequency and consequently back EMF. Additionally, this aids in reducing the magnet's “effective airgap” for the axial machine as q=2 would result in a prohibitively large magnet airgap. The main downside of choosing q=1 is a less sinusoidal back EMF waveform and electrical load ripple. Another alternative would be decreasing the slot pitch; however, this was held constant to facilitate topology comparisons.

The Vernier topology was explored with both q=1 and q=2 as shown in FIG. 6. In particular, FIG. 6 illustrates one coil pole pair for the Vernier topology with fully pitched q=1 (left) q=2 Windings (right). (Note FEA model results presented in the following sections use 5/6 coil pitching for reduced electrical ripple force.) Unlike conventional PM machines, the electrical frequency actually goes down rather than up when moving from q=2 to q=1 given that the slot pitch remains constant. This is due to fewer magnets per unit length when following the Vernier pole pair relationship:

(Magnet pole pairs)=(Stator teeth)−(Winding pole pairs) (2)

It should be noted that one electrical cycle occurs per passage of one magnet pole pair, similar to a conventional machine.

FIG. 7 shows the back EMF waveforms at 1 m/s for all four machines over a period of 200 ms. Both the axial flux and surface PM machines exhibit classic trapezoidal back EMF waveforms. The impact of harmonic coupling with the stator teeth is evident in the waveform peaks, which can be mitigated by skewing the stator stack. The axial flux machine does not have as strong of a flux coupling as the surface PM as evidenced in the lower peak induced voltage.

Over the same 200 ms period shown in FIG. 7, it is apparent that the Vernier topology's electrical frequency is over 5-5.5× greater than the conventional topologies considered, which aids in creating a much higher back EMF. Due to the modulation of the magnet pole faces, the back EMF is also more sinusoidal. The Vernier machine clearly has an advantage over these conventional topologies in that the back EMF voltage is an order of magnitude larger.

It is important to consider cogging forces not only for their impact on mechanical vibration but also on power production. Large cogging forces can produce motoring forces that are not useful and actually negatively impact power production.

Both the axial flux PM and surface PM designs incorporate closed slot design in order to reduce cogging forces. Further reduction in cogging could come from tooth shaping and reduction in slot pitch; however, the slot pitch and tooth/slot width were kept constant to enable side-to-side comparison of the different topologies. As is evident from FIG. 8, the axial flux machine's cogging is four times smaller than the surface PM. The significant cogging in the surface PM highlights the fact that this machine requires great care in applying an optimal tooth shape and stator skew to reduce cogging. The issue of cogging with the surface PM topologies has arisen in previous designs.

The two Vernier topologies exhibit widely different cogging profiles due to their respective magnet configurations. In the q=1 magnet configuration, the magnet inter-pole spacing closely matches the tooth width profile which contributes to larger cogging forces whereas the q=2 configuration reduces the interaction between the teeth and magnet array.

Overall, the Vernier machine with q=2 provides significantly lower cogging forces than any of the other topologies with cogging forces 3 times smaller than even the axial flux machine.

It is of interest to note how a target speed of 1 m/s compares with conventional rotary machines. If the translator within an embodiment of the design envelope herein is wrapped into a rotor shape and rotated at a tangential velocity of 1 m/s, this would equate to just 4.3% of a typical machine's operating speed of 1800 rpm as shown below.
Rotor angular velocity @ 1 m/s rotor tangential speed=1 m/s*(1/(0.244m/2))=8.2 rad/s
Rotor rpm @ 1 m/s rotor tangential speed=8.2 rad/s*30/pi (rpm/rad/s)=78.3 rpm
78.3 rpm/1800 rpm=4.3% of typical optimal electric machine operating speed

Based on the fact that most machines perform poorly at such low speeds, one can fully appreciate the challenge posed by producing high thrust forces with high efficiency in this operating regime. To enable reasonable generator performance at low speed, design changes such as higher turn count and singular slots-per-pole-per-phase defy conventional wisdom for creating a machine with good power factor that also mitigates undesired harmonic content. The reasoning behind this originates from the need to create a significant back EMF to efficiently generate power at low speed/high thrust. The problem here is that while more turn counts increases voltage, it does so at the expense of lower power factor. Similarly, utilizing a single slot-per-pole-per-phase increases voltage at the expense of increased undesired harmonic content.

Power production for the four machine topologies using time-domain simulations was estimated. All simulations were run with a constant translator speed of 1 m/s over a period of 500 ms, starting with zero current for a standardized comparison. Each machine is passively electrically loaded with a capacitor and resistor in series, and all windings are assumed to be 30. The capacitive load is impedance matched to the generator (see next section for details), and the resistive load is swept from the winding resistance (maximum power transfer) to 270 to explore efficiency gains at higher resistive loading. End windings and bearing frictional losses are not considered.

FIG. 9 shows the electrical and mechanical power produced by the surface permanent magnet (PM) topology. This particular topology produces roughly 100 W-275 W with a mechanical input of 100 W-500 W. From the electrical and mechanical power comparison shown in FIG. 9, it is apparent that the cogging forces significantly impact power production especially under higher resistive loading where the generator acts as a motor at times. This feature makes it difficult to ascribe an efficiency metric to this topology. If this design were to be taken forward, further work in tooth shaping and stator skewing would be required to reduce cogging.

There is some room to increase power production by (1) increasing the stator height in order to deepen the stator slots, effectively increasing the number of turns or (2) decreasing the slot pitch, effectively increasing the electrical frequency. Overall, the effect of these changes would be minimal and their deviation from the design envelope would invalidate our method of comparison.

FIG. 10 shows power performance for the axial flux topology. As would be expected from the lower back EMF, this topology produces less power than the surface PM, on the order of 30 W-80 W. Even though the axial flux's cogging is far less than the surface PM's, since the power is so low it also makes a considerable impact on power production. Accordingly, this machine also suffers from a case of motoring as seen in FIG. 10.

FIG. 11 illustrates power and efficiency for the Vernier, q=1 topology. The electrical power produced by this topology is far greater than both the surface and axial flux machines, on the order of 1.6 kW-3.75 kW. Whereas the cogging forces are similar to the surface PM, it does not significantly interfere with power production since this topology is more power dense—i.e. the power attributed to cogging is a small fraction of the overall power. Because this topology does not experience motoring, it is possible to fully explore the range of electrical loads. At this generator's maximum power point, it achieves roughly 50% efficiency; however as the resistive load is increased the efficiency climbs to 90% with only a 2.3× drop in power. Even higher efficiencies are attainable with higher resistive loads, albeit with less output power.

FIG. 12 illustrates power and efficiency for the Vernier, q=2 topology. Given the superior back EMF of this topology over the others, it is no surprise that it produces far more power, on the order of 2.2 kW-6.2 kW. Furthermore, there is no trace of cogging in the output power, leading to a much smoother electrical output. There is, however, some instability at low resistive loads, which is not uncommon, however this is an unlikely operating point as this is the least efficient operating region. FIG. 7 indicates that this generator not only produces far more power but also does so at a much higher efficiency, upwards of 95% at 2.2 kW. Again, this generator is clearly superior to the others.

In order to determine the optimal capacitive loading for each generator, we first find the machine impedance. Equivalent machine inductance is found by performing impedance matching in which the electrical load impedance at maximum power is the complex conjugate of the machine impedance. Through this we find that:

L_{machine}=(ω_{elec}²C_{load})⁻¹ (3)

TABLE 2
Machine Inductance found via Impedance
Matching for Each Topology

| | Peak Load | | Electrical | Equivalent |
|---|---|---|---|---|
| Machine | Capacitance | | Frequency | Machine |
| Topology | @ 1 m/s | | @ 1 m/s | Inductance |
| Surface PM | 34 | mF | 16.3 rad/s, 2.6 Hz | 110 mH |
| Axial PM | 34 | mF | 16.3 rad/s, 2.6 Hz | 110 mH |
| Vernier, q = 1 | 3 | mF | 81.6 rad/s, 13 Hz | 50 mH |
| Vernier, q = 2 | 1.6 | mF | 89.8 rad/s, 14.3 Hz | 83 mH |

Table 3 lists component masses for each machine. This gives an indication of relative material usage within the design envelope criteria. From the data in Table 3, it is clear that that the Vernier topology's unique magnet array is able to incorporate more magnet material in the same unit length. It also contains more copper material within the same design envelope due to the open slot structure. These two factors help explain the higher power production.

TABLE 3
Machine Component Mass

| Machine | Magnet (NdFeB) | Copper | Electrical Steel |
|---|---|---|---|
| Topology | (7550 kg/m³) | (8933 kg/m³) | D = (7872 kg/m³) |
| Axial flux PM | 7392 mm² × | 24713 mm² × 100 mm × fill | (66496 + 19558) mm² × |
| | 100 mm × density = 5.58 kg | factor(0.5) × density = 11 kg | 100 mm × density = 67.7 kg |
| Surface PM | 8316 mm² × | 25435 mm² × 100 mm × fill | (65604 + 3234) mm² × |
| | 100 mm × density = 6.28 kg | factor(0.5) × density = 11.4 kg | 100 mm × density = 54.2 kg |
| Vernier PM, | 19600 mm² × | 39744 mm² × 100 mm × fill | (148368 + 36960) mm² × |
| q = 1 | 100 mm × density = 14.8 kg | factor(0.5) × density = 17.8 kg | 100 mm × density = 145.9 kg |
| Vernier PM, | 21560 mm² × | 39744 mm² × 100 mm × fill | (148368 + 36960) mm² × |
| q = 2 | 100 mm × density = 16.3 kg | factor(0.5) × density = 17.8 kg | 100 mm × density = 145.9 kg |

NOTE:
As the translator is longer than the stator and stroke length is not specified, translator mass is only quantified within stator

TABLE 4
Power Density Comparison

| Machine Topology | Machine Mass | | Maximum Power | | Power Density | |
|---|---|---|---|---|---|---|
| Axial flux PM | 84.28 | kg | 80 | W | 0.95 | W/kg |
| Surface PM | 71.88 | kg | 500 | W | 6.96 | W/kg |
| Vernier PM, q = 1 | 178.5 | kg | 3.75 | kW | 21 | W/kg |
| Vernier PM, q = 2 | 180 | kg | 6.2 | kW | 34.4 | W/kg |

Given the Vernier PM with q=2 topology's superior power and efficiency characteristics as well as its comparatively high power density, some embodiments of this invention may employ this topology.

Some embodiments may also incorporate known methods for reducing cogging including skewing the stator with respect to the translator or special stator tooth shaping. These techniques reduce the abrupt changes in permeability seen through the airgap at the cost of increased assembly complexity.

Additional embodiments may employ a machine in which either the stator or translator has no iron parts, yet these machines have low force density.

Yet another embodiment is to use a surface PM machine as opposed to a buried PM machine (axially aligned PMs as shown in the example Vernier, q=2 configuration above). This may help alleviate cogging since a surface magnet adds to the effective airgap due to the PM's near unity relative permeability. Again, this is an important design factor since the reduction of cogging forces yields significant structural savings and decreases power fluctuation.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

1. An apparatus for converting mechanical energy to electrical energy, the apparatus comprising:
a linear electrical generator comprising:
at least one translator with translator poles; and
at least one stator with stator poles, wherein the stator poles are aligned with the translator poles according to a Vernier scale;
wherein for given lengths of the stator and translator, the number of stator poles in the stator is offset by an integer number of translator poles in the translator.

2. The apparatus of claim 1, wherein the linear electrical generator comprises a permanent magnet generator.

3. The apparatus of claim 1, wherein the stator poles are located on opposing sides of the translator.

4. The apparatus of claim 1, wherein the stator poles are located on one side of the translator.

5. The apparatus of claim 1, wherein for a given length of stator and translator, the number of stator poles in the stator is more than the number of translator poles in the translator.

6. The apparatus of claim 1, wherein for the given lengths of the stator and the translator, the number of stator poles in the stator is less than the number of translator poles in the translator.

7. The apparatus of claim 1, where permanent magnets are arranged in a configuration with one slot per pole per phase.

8. The apparatus of claim 1, wherein the linear electrical generator further comprises permanent magnets, and the permanent magnets are arranged in a configuration with two slots per pole per phase.

9. A method of converting mechanical energy captured to electrical energy, the method comprising:
subjecting at least one linear electrical generator to mechanical energy from ocean waves, wherein the linear electrical generator comprises at least one translator aligned relative to at least one stator so that a plurality of stator poles are positioned relative to a plurality of translator poles according to a Vernier scale, wherein for a given length of stator and translator, the number of poles in the stator are offset by an integer number of poles; and
generating electrical energy from the mechanical energy in response to relative movement between the plurality of stator poles and the plurality of translator poles.

10. The method of claim 9, wherein the linear electrical generator comprises a permanent magnet generator.

11. The method of claim 9, wherein the plurality of stator poles moves along at least two sides of the plurality of translator poles.

12. The method of claim 9, wherein the plurality of stator poles moves along a single side of the plurality of translator.

13. The method of claim 9, wherein for a unit length, the number of the stator poles in the stator is more than the number of the translator poles in the translator.

14. The method of claim 9, wherein for a unit length, the number of the stator poles in the stator is less than the number of the translator poles in the translator.

15. The method of claim 9, wherein for a unit length, the number of the stator poles in the stator is at least one more than the number of the translator poles in the translator.

16. The method of claim 9, wherein for a unit length, the number of the stator poles in the stator is at least one less than the number of the translator poles in the translator.

17. The method of claim 9, wherein permanent magnets are arranged in a configuration of one slot per pole per phase.

18. The method of claim 9, wherein permanent magnets are arranged in a configuration of two slots per pole per phase.

19. An apparatus for converting mechanical energy in ocean waves to electrical energy, the apparatus comprising:
a surface float configured to be subject to mechanical energy from ocean waves and to transfer at least a portion of this mechanical energy to at least one drivetrain contained within the surface float, wherein the drivetrain comprises at least one linear electrical generator comprising:
at least one translator; and
at least one stator;
wherein the linear electrical generator is configured such that the alignment of stator and translator poles is analogous to a Vernier scale, wherein for a given length of stator and translator, a number of poles in the stator are offset by an integer number of poles in the translator.

20. The apparatus of claim 19, further comprising a force modification system that changes the mechanical energy between the surface float and the linear electrical generator.
